(19) United States
(12) Patent Application Publication
(10) Pub. No.: US 2026/0269764 A1
(43) Pub. Date: Sep. 10, 2026

(54) MOTOR CONTROL DEVICE

(71) Applicant: Astemo, Ltd., Chiyoda-ku, Tokyo (JP)

(72) Inventors: Yasuaki SATO, Hitachinaka-shi, Ibaraki (JP); Shogo MIYAMOTO, Hitachinaka-shi, Ibaraki (JP); Shigehisa AOYAGI, Hitachinaka-shi, Ibaraki (JP); Takaya TSUKAGOSHI, Hitachinaka-shi, Ibaraki (JP); Hiroyuki OOIWA, Hitachinaka-shi, Ibaraki (JP); Takashi OKADA, Hitachinaka-shi, Ibaraki (JP); Yuki OKUDA, Hitachinaka-shi, Ibaraki (JP)

(73) Assignee: Astemo, Ltd., Chiyoda-ku, Tokyo (JP)

(21) Appl. No.: 19/164,613

(22) PCT Filed: Apr. 26, 2023
(86) PCT No.: PCT/JP2023/016395

§ 371 Date: Sep. 12, 2025

(51) Int. Cl. H02P 29/62; B60L 3/00; B60L 15/00; B60L 15/20; H02P 23/04; H02P 23/14; H02P 29/68

(52) U.S. Cl. CPC H02P 29/62; B60L 3/0061; B60L 15/007; B60L 15/20; H02P 23/04; H02P 23/14; H02P 29/68; B60L 2210/40; B60L 2240/36

(57) ABSTRACT

An object of the present invention is to achieve a motor control device being a technology that uses a motor as a heater while the motor is not in rotation, that is capable of distributing generation of heat through effective use of three-phase coils, that is, by changing the current application cycles to the respective phases on the basis of the temperature difference between the UVW phases, and that is capable of increasing the thermal energy usable for raising the temperature and of improving the torque stability at the time of switching from warm-up to drive. A motor control device 100 controls an alternating-current motor 16 driven by a power conversion unit 15 that performs power conversion from direct-current power to alternating-current power. The motor control device 100 includes phase output units 22, 26, 27, 28, and 29 that control the phase of current or the phase of voltage based on the position of a rotor of an alternating-current motor 16 while the alternating-current motor 16 is not in rotation, and a coil temperature acquisition unit 21 that acquires or estimates the temperature of the coils of respective phases of the alternating-current motor 16, and phase output units 22, 26, 27, 28, and 29 control the phase of the current or the phase of the voltage so as to increase the loss of a phase having the low temperature, among the temperatures of the coils of the respective phases.

### TECHNICAL FIELD

The present invention relates to a motor control device.

### BACKGROUND ART

In electric vehicles, the cabin and the battery do not warm up quickly during the time of a low temperature (lower than or equal to a freezing point), e.g., during the winter time, due to the lack of sufficient heat source, and therefore, electric vehicles require control for warming up the motor during the time of a low temperature.

PTL 1 describes a technique for improving the torque of a motor as a whole, by allowing more current to flow through a low-temperature stator coil than that flowing through a high-temperature stator coil.

Described therein is that, provided that there are m stator coils, and the temperatures of p stator coils are lower than the temperatures of the remaining (m-p) stator coils, applying alternating currents having phases offset from each other by 360°/p but having the same amplitude to the p stator coils, and applying alternating currents having phases offset from each other by 360°/(m-p) but having the same amplitude to the (m-p) coils.

### CITATION LIST

### Patent Literature

PTL 1: JP 2010-206897 A

### SUMMARY OF INVENTION

### Technical Problem

Efforts have been made to quickly warm up an electric vehicle by using a motor as a heater while the motor is not in rotation.

The technique described in PTL 1 is a technique in which a motor coil having a part thereof in a refrigerant corresponds to a low-temperature coil, and only the current to be passed through the phase of the low-temperature coil while the motor is in rotation is increased.

With the technique in which a motor is used as a heater while the motor is not in rotation, however, if high current is applied to the low-temperature coil of a specific phase, the coil of the specific phase becomes heated and an output limitation prohibits any further generation of heat, so that effective use of the coils of the other phases is obstructed. Therefore, it has been difficult to use the motor in raising the temperature any further (to input energy for raising the temperature).

An object of the present invention is to achieve a motor control device being a technology that uses a motor as a heater while the motor is not in rotation, that is capable of distributing generation of heat through effective use of three-phase coils, that is, by changing the time lengths for which the current is applied to the respective phases on the basis of the temperature difference between the UVW phases, and that is capable of increasing the thermal energy usable for raising the temperature, and capable of improving the torque stability at the time of switching from warm-up to drive.

### Solution to Problem

In order to achieve the object stated above, the present invention is configured as follows.

A motor control device that controls an alternating-current motor driven by a power conversion unit converting power from direct-current power to alternating-current power, the motor control device includes: a phase output unit that controls a phase of current or a phase of voltage based on a position of a rotor of the alternating-current motor, during a non-rotating state of the alternating current motor; and a coil temperature acquisition unit that acquires or estimates temperatures of coils corresponding to respective phases of the alternating-current motor during the non-rotating state of the alternating-current motor, in which the phase output unit controls the phase of the current or the phase of the voltage so as to increase a loss of a phase corresponding to a coil exhibiting a low temperature, among the temperatures of the coils corresponding to the respective phases.

### Advantageous Effects of Invention

According to the present invention, it is possible to achieve a motor control device being a technology that uses a motor as a heater while the motor is not in rotation, that is capable of distributing generation of heat through effective use of three-phase coils, that is, by changing the time lengths for which the current is applied to the respective phases on the basis of the temperature difference between the UVW phases, and that is capable of increasing the thermal energy usable for raising the temperature, and capable of improving the torque stability at the time of switching from warm-up to drive.

### BRIEF DESCRIPTION OF DRAWINGS

FIG. 1 is an overall configuration diagram of a motor control device according to an embodiment of the present invention.

FIG. 2 is a diagram of an internal configuration of an overall phase calculation unit in the motor control device according to the embodiment of the present invention.

FIG. 3 is a diagram for explaining an example of an operation of determining a target loss.

FIG. 4 is a diagram for explaining an internal configuration of a warm-up phase correction unit included in the overall phase calculation unit.

FIG. 5 is a diagram illustrating a phase conversion table of the warm-up phase correction unit.

FIG. 6 is a diagram for explaining a temperature difference between the coils of UVW phases.

FIG. 7 is a diagram for explaining a method of determining time lengths by which the phases are changed on the basis of coil temperatures.

FIG. 8 is a diagram for explaining a method of setting a current cycle, on the basis of the temperatures of switch elements.

FIG. 9 is a diagram for explaining a method of setting a current cycle, on the basis of the temperatures of the switch elements.

### DESCRIPTION OF EMBODIMENTS

An embodiment of the present invention will now be described with reference to drawings.

### Embodiments

### First Embodiment

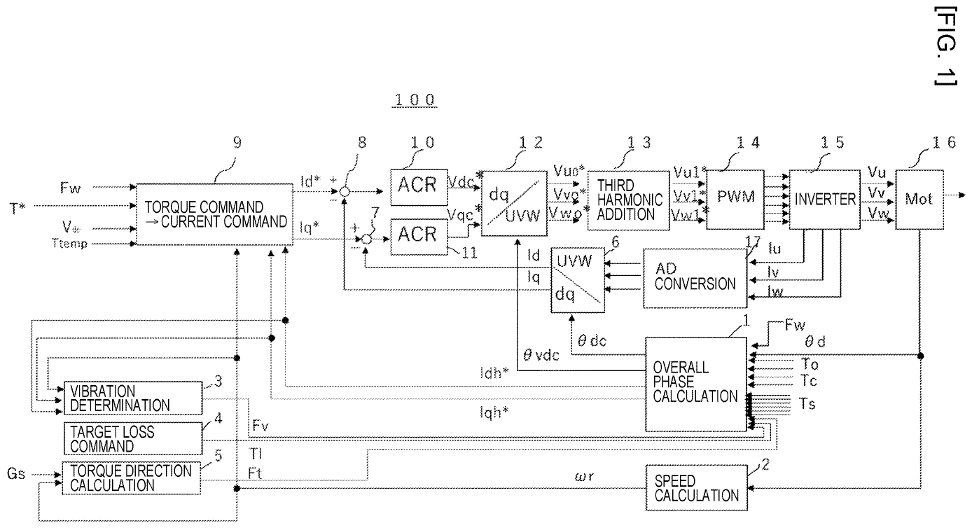

FIG. 1 is an overall configuration diagram of a motor control device 100 according to an embodiment of the present invention.

In FIG. 1, an overall phase calculation unit 1 receives inputs of a warm-up flag Fw, an electrical angle θd that is a detection value of the positions of the magnetic poles, an outside air temperature To, coil temperatures Tc, switch element temperatures Ts, a vibration flag Fv, a target loss value Tl, and a torque direction flag Ft.

The overall phase calculation unit 1 calculates a phase θdc at the time of calculation, and outputs this phase to a dq current conversion unit 6. The overall phase calculation unit 1 also outputs a command phase θvc to a voltage conversion unit 12, and outputs current command values Idh* and Igh* to a current command conversion unit 9 and a vibration determination unit 3.

A speed calculation unit 2 calculates the speed of the alternating-current motor 16, and outputs the rotation speed ωr to a torque direction calculation unit 5 and the current command conversion unit 9. The vibration determination unit 3 generates a vibration flag Fv, on the basis of the current command values Idh*, Iqh* and the rotation speed ωr, and outputs the vibration flag Fv to the overall phase calculation unit 1.

A target loss command unit 4 outputs the target loss value Tl to the overall phase calculation unit 1. The torque direction calculation unit 5 outputs the torque direction flag Ft to the overall phase calculation unit 1, on the basis of a longitudinal G-sensor value Gs and the rotation speed ωr.

The current command conversion unit 9 calculates current command values Id* and Iq*, on the basis of the warm-up flag Fw, a torque command T*, an inverter input voltage Vdc, the torque direction flag Ft, and the current command values Idh* and Igh *. A subtractor 8 subtracts a d-axis current value Id output from the dq current conversion unit 6, from the current command value Id*, and supplies the result to a current control unit 10. A subtractor 7 subtracts a q-axis current value Iq output from the dq current conversion unit 6, from the current command value Iq*, and supplies the result to a current control unit 11.

The current control unit 10 calculates a voltage command value Vdc*, and supplies the voltage command value Vdc* to the voltage conversion unit 12. The current control unit 11 calculates a voltage command value Vqc*, and supplies the voltage command value Vqc* to the voltage conversion unit 12. The voltage conversion unit 1 calculates voltage command values Vuo*, Vvo*, and Vwo* for the respective phases, and supplies voltage command values Vu1*, Vv1*, and Vw1* for the respective phases, with harmonics added thereto, to a PWM conversion unit 14 via a three-dimensional harmonic adder unit 13. Voltage command values having been subjected to pulse-width modulation of the PWM conversion unit 14 are supplied to the inverter (power conversion unit) 15.

From the inverter 15, voltages Vu, Vv, and Vw are supplied to the motor 16. The inverter 15 also supplies current values Iu, Iv, and Iw to an AD conversion unit 17, and the current values subjected to the AD conversion are supplied to the dq current conversion unit 6.

In the embodiment of the present invention, the phases of the voltage output to the motor 16 are changed by detecting the positions of the magnetic poles of the motor 16 and by outputting the phase at the time of a command. The current command values Idh* and Igh* are output to the current command conversion unit 9, and the warm-up operation of the motor 16 is performed on the basis of the current command values Id* and Iq*.

The output signal (vibration flag Fv) from the vibration determination unit 3 and the output signal (torque direction flag Ft) from the torque direction calculation unit 5 may be processed and issued by a device other than the motor control device 100. For example, these output signals may be commanded by a higher-level controller (not illustrated).

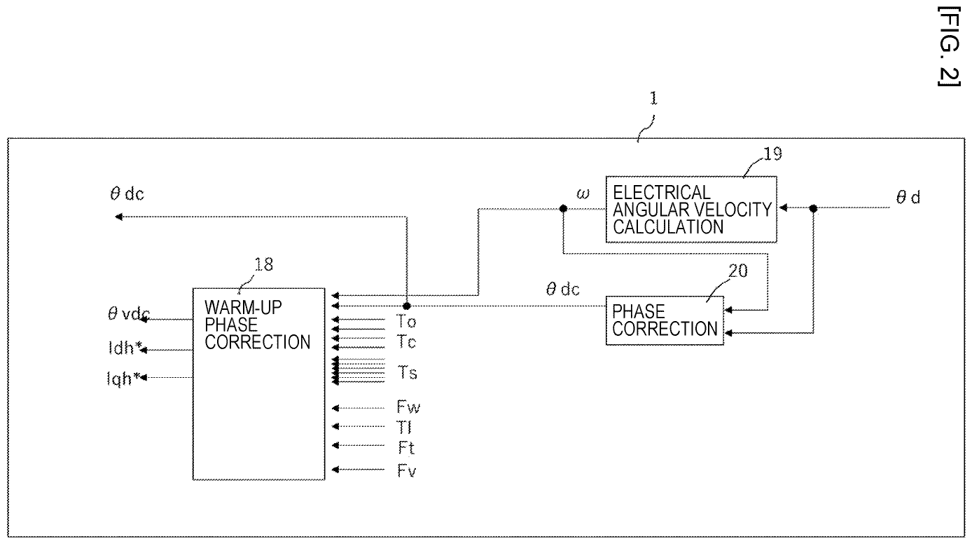

FIG. 2 is a diagram of an internal configuration of the overall phase calculation unit 1 in the motor control device 100 according to the embodiment of the present invention.

In FIG. 2, an electrical angular velocity calculation unit 19 calculates an electrical angular frequency ω from the electrical angle θd, and outputs the electrical angular frequency ω to the warm-up phase correction unit 18 and a phase correction unit 20. The phase correction unit 20 outputs the phase θdc at the time of calculation used for ordinary control, from the electrical angle θd and the electrical angular frequency ω, and outputs the phase θdc at the time of calculation to the warm-up phase correction unit 18. As illustrated in FIG. 1, the phase θdc at the time of calculation is also output to the dq current conversion unit 6.

The electrical angular frequency ω, the phase θdc at the time of calculation, the outside air temperature To, the coil temperatures Tc, the switch element temperatures Ts, the warm-up flag Fw, the target loss value Tl, the torque direction flag Ft, and the vibration flag Fv are input to the warm-up phase correction unit 18. The warm-up phase correction unit 18 then outputs a command phase θvdc and the current command values Idh* and Igh*, which are the current values at the time of the warm-up command.

Warm-up control is performed by changing the position of the rotor (voltage phases) with respect to that in the normal control, to the command phase θdc and the current command values Idh* and Iqh*.

The target loss value Tl input to the warm-up phase correction unit 18 will now be described. The target loss value Tl is output from the target loss command unit 4 illustrated in FIG. 1 to the warm-up phase correction unit 18.

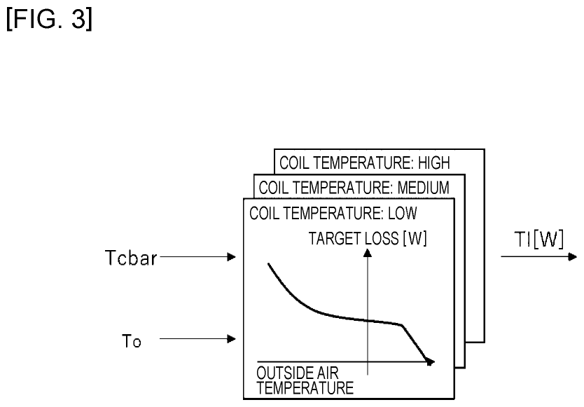

FIG. 3 is a diagram for explaining an operation by which the target loss command unit 4 determines a target loss. In FIG. 3, the target loss command unit 4 receives inputs of an average coil temperature Tcbar and the outside air temperature To. The target loss command unit 4 has a table including a predetermined relationship between an outside air temperature To and a target loss Tl (W), for each of high, medium, and low average temperatures Tcbar. On the basis of these tables, a target loss Tl for a coil is determined. The target loss command unit 4 calculates a necessary loss from the outside air temperature, and reduces the loss value when the coil temperature is high and near the desirable temperature. From this target loss value, a current command value is determined.

The relationship between the outside air temperature To and the target loss Tl (W) may be set in any way.

Furthermore, the target loss Tl (W) may be output directly from a higher-level controller (not illustrated) to the warm-up phase correction unit 18.

FIG. 4 is a diagram for explaining an internal configuration of the warm-up phase correction unit 18 included in the overall phase calculation unit 1.

In FIG. 4, a temperature determination unit 21 detects a temperature difference between a U-phase coil temperature TeCU, a V-phase coil temperature TeCV, and a V-phase coil temperature TeCW, and outputs the temperature difference to a cycle ratio determination unit 22.

The temperature determination unit (coil temperature acquisition unit) 21 outputs temperature phase information Tpi indicating the phase the coil of which is exhibiting the highest temperature and the phase the coil of which is exhibiting the lowest temperature, among the coil temperature TeCU, the coil temperature TeCV, and the coil temperature TeCW, to a loss-cycle correspondence output unit 27. The temperature phase information Tpi can be defined as, for example, “1” when the coil temperature TeCU is the highest and the coil temperature TeCV is the lowest; “2” when the coil temperature TeCU is the highest and the coil temperature TeCW is the lowest; “3” when the coil temperature TeCV is the highest and the coil temperature TeCU is the lowest; “4” when the coil temperature TeCV is the highest and the coil temperature TeCW is the lowest; “5” when the coil temperature TeCW is the highest and the coil temperature TeCU is the lowest; and “6” when the coil temperature TeCW is the highest and the coil temperature TeCV is the lowest.

The cycle ratio determination unit 22 determines the cycle ratio (ratio of energization time) Pr for each of the phases, on the basis of a table indicating the relationship between a temperature difference ΔT and a cycle ratio. The cycle ratio determination unit 22 then outputs the determined cycle ratio Pr to the loss-cycle correspondence output unit 27.

The cycle ratio determination unit 22 determines the cycle at which the current is to be passed, based on the temperature difference between the phases. That is, because the duration of time for which the current is passed is determined based on the difference in temperature between the phases, the duration of time for which the current is passed (long, medium, short) is determined in the order of temperatures.

A phase conversion unit 29 receives the torque direction flag Ft and the phase θdc at the time of calculation, and outputs correction phases (θdcVHU, θdcVHV, θdcVHW), which are the voltage phases matching the torque direction, to the loss-cycle correspondence output unit 27. These correction phases (θdcVHU, θdcVHV, θdcVHW) are correction phases making the losses of the respective phases the same, when such correction phases are cyclically output, and are electrical angle phases not making the current value of any specific one of the phases zero, because all of the phases are warmed up equally and the temperature increases of the phases are accelerated.

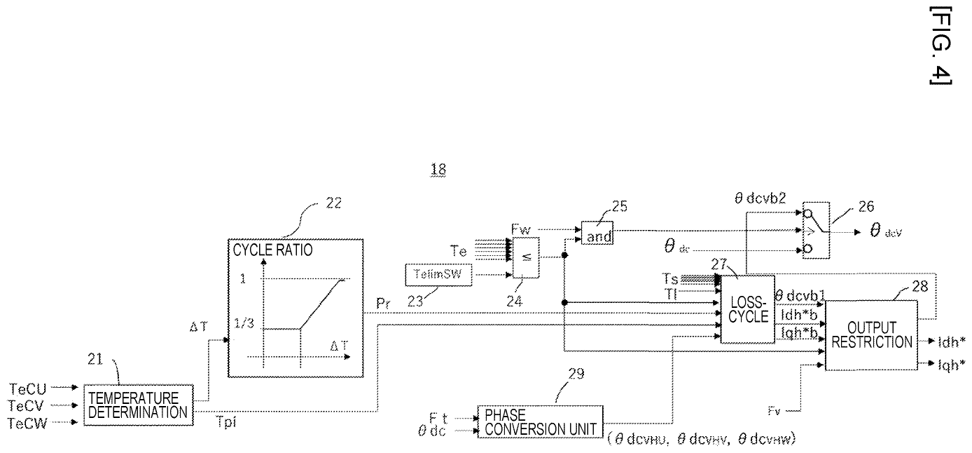

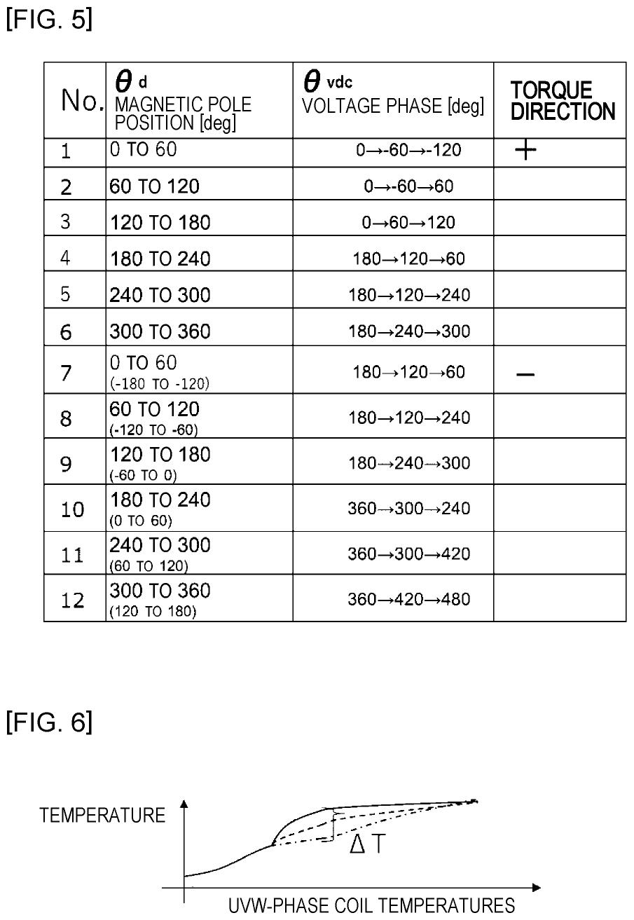

FIG. 5 is an example of a table provided in the phase conversion unit 29, and indicating current patterns corresponding to the respective phases. The table illustrated in FIG. 5 indicates a correspondence between a magnetic pole position ed and voltage phases Ovdc, correspondingly to each of the torque directions (+, −).

As illustrated in FIG. 5, voltage phases achieving the maximum current value in each of the U phase, the V phase, and the W phase, are set in advance, with respect to the positions of the magnetic poles. With this, it is possible to designate a state in which the highest current flows through one of the phases (the phase with the lowest temperature) . By determining the time for which the highest current flows through the phase of a coil having the lowest temperature, it is possible to increase the loss and to raise the temperature of the one of the phases (phase having the lowest temperature).

In other words, it is possible to change the voltage phases in such a manner that the current flowing through one of the phases (low-temperature phase) is increased. Furthermore, there are three voltage phases corresponding to the positions of the magnetic poles, so that it is possible to switch to voltage phase achieving the highest absolute current value in specific one of the phases (low-temperature phase). The three voltage phases can be selected from the phases close to the positions of the magnetic poles of the motor 16 in the non-rotating state.

Note that the table illustrated in FIG. 5 is merely an example, and it is also possible to use another method to calculate the correction phase.

In FIG. 4, the loss-cycle correspondence output unit 27 receives the target loss value Tl, the warm-up flag Fw, the ratio output Pr, the temperature phase information Tpi, and the correction phases (θdcVHU, θdcVHV, θdcVHW), and outputs current values (Idh*b, Iqh*b) and an electrical phase (θdcvb1) corresponding to the target loss value Tl to an output restriction unit 28. In this case, the loss-cycle correspondence output unit 27 is configured to retain a line indicating a current value corresponding to a target loss value Tl in a storage unit (not illustrated), in advance. In this manner, it is possible to bring the loss to a value within the target loss value.

The loss-cycle correspondence output unit 27 outputs the current values (Idh*b, Igh*b) and the electrical phase (θdcvb1) cyclically in accordance with the cycle ratio Pr. Specifically, the duration of time for which the current is passed through the low-temperature phase is increased so as to increase the loss of the low-temperature phase.

In the embodiment, the duration of time for which the current is passed through the low-temperature phase is increased, but it is also possible to increase the current value instead.

The output restriction unit 28 outputs a pre-correction command phase θdcvb2, and warm-up command current values Idh* and Iqh*. When the vibration flag Fv (0: no vibration, 1:
vibration) is detected, the output restriction unit 28 operates to reduce the current value. In this case, an operation is performed in such a manner that the electrical phase gradually changes from the current electrical angle phase so as not to change quickly.

The temperature determination unit 24 receives the switch element temperatures Te and a temperature limit from a temperature limit switch 23, and the temperature determination unit 24 determines whether the switch element temperatures Te are equal to or lower than the temperature limit. The determination result is output to an AND circuit 25.

The AND circuit 25 receives the warm-up flag Fw. The warm-up flag Fw indicates a warm-up request, and when the switch element temperatures Te are equal to or lower than the temperature limit, the AND circuit 25 outputs an output for enabling the warm-up control. It is also possible for the AND circuit 25 to receive an input of the vibration flag Fv, and to enable the warm-up control upon satisfaction of conditions that: the warm-up is requested by the warm-up flag Fw; the switch element temperatures Te are equal to or lower than the temperature limit; and there is no vibration. The output of the AND circuit 25 is supplied to a phase selection unit 26, the loss-cycle correspondence output unit 27, and the output restriction unit 28.

The pre-correction command phase θdcvb2r, the original phase (beginning phase) θdc, and the output from the AND circuit 25 are supplied to the phase selection unit 26, and, when the warm-up control is enabled, a command phase pre-correction θdcvb2 that changes cyclically is output as a final phase θdcv.

The torque direction flag Ft input to phase conversion unit 29 is output from the torque direction calculation unit 5 in FIG. 1. The torque direction calculation unit 5 determines a torque direction not causing any vibration, on the basis of the longitudinal G-sensor value Gs and the rotation speed wr. The torque direction is determined by determining which of the positive and negative torque directions is better in exerting a torque in the direction in which gears of the motor 16 become meshed. The torque direction calculation unit 5 calculates the direction of the torque in which the motor 16 does not move or moves only within a predetermined limited range of movement. With the torque direction calculation unit 5 outputting the torque direction flag Ft indicating that the direction not rotating or moving the motor 16 only within the limited range of movement, it becomes possible to output the voltage phases corresponding to the torque direction.

Specifically, the torque direction calculation unit 5 predicts a gradient from the longitudinal G-sensor value Gs and a change in acceleration of the rotation speed of the motor 16, and estimates the torque direction not causing the motor 16 to rotate by being applied with a +/− side motor torque, on the basis of the meshing of the gears connecting the rotational shaft of the motor 16 to a drive shaft.

The meshing of the gears is determined using the longitudinal sensor value Gs, and + or − in the torque direction is determined. It is also possible to determine + or − in the torque direction by detecting the changes in the current value and the rotational frequency of the motor 16.

The target loss value Tl input to the loss-cycle correspondence output unit 27 is output from the target loss command unit 4 illustrated in FIG. 1 to the loss-cycle correspondence output unit 27. The target loss command unit 4 outputs the target loss value Tl on the basis of the outside air temperature, cooling water, and coil temperatures. The target loss value Tl may also be commanded by the higher-level controller (not illustrated).

The vibration flag Fv input to the output restriction unit 28 is output from the vibration determination unit 3 illustrated in FIG. 1. The vibration determination unit 3 detects a fluctuation in the rotational frequency of the motor 16, to determine if there is a vibration, and sets the vibration flag Fv to 0 when there is no vibration, and sets the vibration flag Fv to 1 when there is vibration. The vibration determination unit 3 outputs whether there is any fluctuation in the rotational frequency of the motor 16 during the warm-up operation with the current command value. The vibration determination unit 3 detects rotation and shaking (vibration) of the motor 16 during the warm-up operation, shaking (vibration) of the vehicle having the motor control device 100 onboard, and a change in the current command value, and outputs whether the motor 16 is in rotation. When there is shaking due to the output, the output restriction unit 28 can restrict the output by reducing the magnitude of the current command value, to suppress the vibration by further reducing the torque being generated.

The output restriction unit 28 may be configured to, in addition to restricting the output in response to the vibration determination from the vibration flag Fv, refrain from performing (stop) the phase control or lower the current command value, when the temperatures of the switch elements in the power conversion unit 15 exceed a limit value, on the basis of the output signal from the temperature determination unit 24, so as to reduce the chances of degradation or to prevent a failure of the switch elements.”

A method for determining the cycle at which the phases are changed, on the basis of the UVW-phase coil temperatures will now be described with reference to FIGS. 6 and 7.

On the basis of the temperature difference ΔT (indicated in FIG. 6) between the highest coil temperature and the lowest coil temperature output from the temperature determination unit 21, time lengths T1, T2, and T3 (indicated in FIG. 7) are determined, in accordance with the cycle ratio Pr determined by the cycle ratio determination unit 22. Alternatively, the time lengths T1, T2, and T3 are determined on the basis of the temperature difference ΔT between the highest coil temperature and the lowest coil temperature, and of a difference ΔT1 between the first highest coil temperature and the second highest coil temperature.

As a calculation method, the cycle ratios for T1, T2, and T3 are determined by, using FIG. 7 as an example, causing the cycle ratio determination unit 22 to determine the cycle ratio of the phase of the coil having the lowest temperature (determines T3/(T1+T2+T3)=Pr), given ΔT as an input, and causing the cycle ratio determination unit 22 to determine the cycle ratio of the coil phase having the second lowest temperature (T2/(T2+T1)=cycle ratio), given ΔT1 as an input, (using maps dedicated for the second and third, or the same map as that of the cycle ratio determination unit 22).

The values of the currents flowing through the UVW phases, respectively, are changed by changing the correction phases (θdcVHU, θdcVHV, θdcVHW) output from the phase conversion unit 29, in accordance with the cycle ratio Pr. The cycle of the voltage phases is changed, on the basis of the differences in the coil temperatures of the respective phases, so that the voltage phases result in an increase in the current to be passed to the phase having the lower temperature.

The current command values (Idh*b, Iqh*b) are determined on the basis of the target loss Tl and an acceptable torque input to the loss-cycle correspondence output unit 27, and as a result, the maximum current value Cv for the UVW phases is determined.

In the example illustrated in FIG. 7, in the time length T1, the current value (solid line) of the U phase is set to the current value Cv, and the current values of the V phase and the current value of the W phase are set to ½ of the current value Cv. In the time length T2, the current value (broken line) of the V phase is set to the current value Cv, and the current values of the U phase and the current value (alternate long and short dash line) of the W phase are set to ½ of the current value Cv. In the time length T3, the current value of the W phase is set to the current value Cv, and the current values of the U phase and the current value of the V phase are set to ½ of the current value Cv.

When the temperature difference is small, the current command value and the voltage phases are changed cyclically so that the U phase, the V phase, and the W phase have the same loss (energy consumption). By making a time-averaged loss of each of the phases the same, the coil temperatures of the U phase, the V phase, and the W phase can be maintained at the equal temperatures.

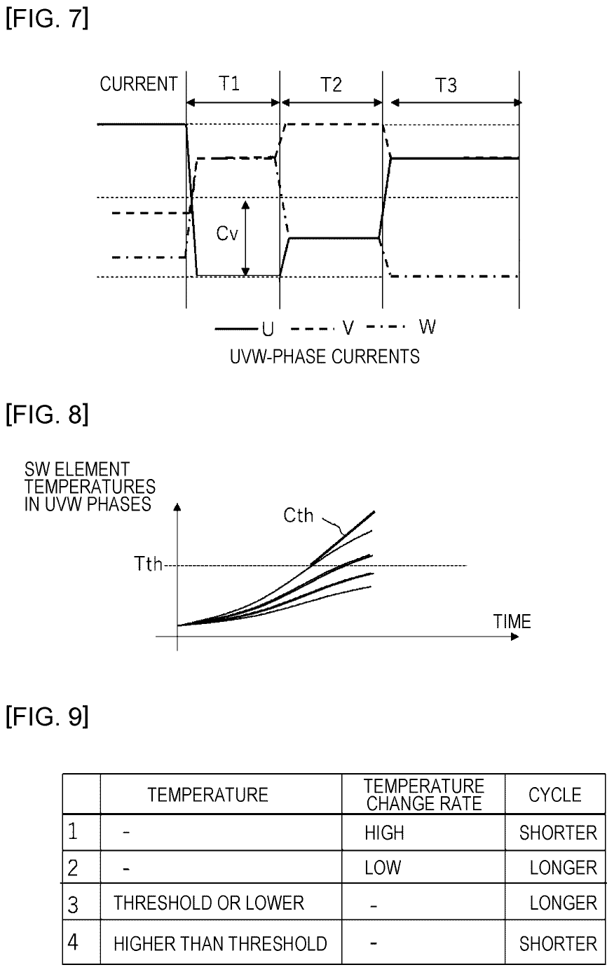

FIGS. 8 and 9 are diagrams for explaining a method of setting a current cycle, on the basis of the temperatures of the switch elements.

In FIG. 8, it is determined whether the temperatures of the plurality of switch elements in each of the UVW phases increase over time, and become higher or lower than or equal to a cycle-changing temperature threshold Tth. It is also determined whether the rates of the temperature changes in the plurality of switch elements in each of the UVW phases are higher or lower than a cycle-changing temperature-change rate threshold Cth.

As illustrated in FIG. 9, if the temperatures are equal to or lower than the cycle-changing temperature threshold Tth, the cycle of the voltage phase cycle is extended. If the temperatures are higher than the threshold, the cycle of the voltage phase cycle is shortened. Alternatively, if the rates of the temperature changes are higher than the cycle-changing temperature-change rate threshold Cth, the cycle of the voltage phase cycle is shortened. If the rates of the temperature changes are lower than the cycle-changing temperature-change rate threshold Cth, the cycle of the voltage phase cycle is extended. It is thus possible to prevent current from continuously flowing through the switch elements and to suppress deterioration of the switch elements.

Because the present invention is configured as described above, it is possible to achieve a motor control device 100 being a technology that uses a motor 16 as a heater while the motor 16 is not in rotation, that is capable of distributing generation of heat through effective use of three-phase coils, that is, by changing the time lengths for which the current is applied to the respective phases on the basis of the temperature difference between the UVW phases, and that is capable of increasing the thermal energy usable for raising the temperature, and capable of improving the torque stability at the time of switching from warm-up to drive.

According to the present invention, the voltage phases to which the current is passed are determined on the basis of the temperature difference between the highest and the lowest ones of the temperatures of the U-phase, V-phase, and W-phase coils, respectively, while the motor 16 is not in rotation. When there is a large temperature difference, the cycle is changed so as to extend the duration of time for which the current is passed through the phase with the low temperature, and the voltage phases are changed in such a manner that the current value of the low-temperature phase is maximized.

As a result, the loss of the low temperature phase is increased, so that it is possible to achieve the effect of promoting the temperature rise for the phase with the low temperature, among the U phase, the V phase, and the W phase.

In addition, it is possible to equalize the losses of the U phase, the V phase, and the W phase while the motor 16 is not in rotation, and to maximize the efficiency of the heat storage effect, while protecting the inverter and ensuring the temperature balance among the phases of the motor 16.

In addition, the heat storage effect can be used in quickly raising the temperatures of the cabin, the battery, and the gear oil, and for a heat source required during traveling of the vehicle.

Furthermore, because the present invention has a control configuration that makes use of the existing control, the present invention can be implemented without a significant change in an ordinary motor control configuration.

In the embodiment described above, the present invention has been described using a magnet motor as a basic configuration (to control phases of the current or voltage on the basis of the positions of the magnetic poles), but the present invention is also applicable to other motors (such as a wound field motor). In such a case, the magnetic pole position is defined as a rotor position.

Furthermore, in the embodiment described above, when there is a vehicle requirement for suppressing the generated torque, it is possible to extend the time of a voltage phase by which the torque is reduced (provided that the coil temperature is lower than an acceptable level).

The cycle ratio determination unit 22, the phase selection unit 26, the loss-cycle correspondence output unit 27, the output restriction unit 28, and the phase conversion unit 29 together form a phase output unit.

Furthermore, the state in which the motor 16 is not in rotation is defined as a state in which the rotation shaft of the motor 16 is in contact with a stop gear and the motor 16 is prohibited from rotating.

In addition, the example described above is an example in a case where the present invention is applied to drive control of a three-phase motor, but the present invention is also applicable to drive control of an N-phase motor, such as six-phase or nine-phase motors, other than the three-phase motor.

### REFERENCE SIGNS LIST

1 overall phase calculation unit
2 speed calculation unit
3 vibration determination unit
4 target loss command unit
5 torque direction calculation unit
6 dq current conversion unit
7, 8 subtractor
9 current command conversion unit
10, 11 current control unit
12 voltage conversion unit
13 third harmonic adder unit
14 PWM conversion unit
15 inverter (power conversion unit)
16 alternating-current motor
17 AD conversion unit
18 warm-up phase correction unit
19 electrical angular velocity calculation unit
20 phase correction unit
21 temperature determination unit (temperature acquisition unit)
22 cycle ratio determination unit
23 temperature limit switch
24 temperature determination unit
25 AND circuit
26 phase selection unit
27 loss-cycle correspondence output unit
28 output restriction unit
29 phase conversion unit
100 motor control device
Cth cycle-changing temperature-change rate threshold
Ft torque direction flag
Fv vibration flag
Fw warm-up flag
Gs longitudinal G-sensor value
Idh*, Igh* current command value
Pr cycle ratio
Tc coil temperature
Te switch element temperatures
Tl target loss value
To outside air temperature
Tpi temperature phase information
Ts switch element temperatures
Tth cycle-changing temperature threshold
T* torque command
Vdc inverter input voltage
ωr rotation speed
θd electrical angle (detection value of position of magnetic pole)
θdc phase at the time of calculation
θvc command phase
θvdc command phase θdcvb2 pre-correction command phase

1. A motor control device that controls an alternating-current motor driven by a power conversion unit converting power from direct-current power to alternating-current power, the motor control device comprising:
a phase output unit that controls a phase of current or a phase of voltage based on a position of a rotor of the alternating-current motor, during a non-rotating state of the alternating-current motor; and
a coil temperature acquisition unit that acquires or estimates temperatures of coils corresponding to respective phases of the alternating-current motor during the non-rotating state of the alternating-current motor,
wherein the phase output unit controls the phase of the current or the phase of the voltage so as to increase a loss of a phase corresponding to a coil exhibiting a low temperature, among the temperatures of the coils corresponding to the respective phases.

2. The motor control device according to claim 1, wherein the phase output unit switches the phase of the voltage in accordance with a position of the rotor so as to increase the loss of the phase exhibiting the low temperature, among the temperatures of the coils of the respective phases.

3. The motor control device according to claim 1, wherein the non-rotating state of the alternating-current motor is a state in which the alternating-current motor is prohibited from rotating by having a rotation shaft of the alternating-current motor in contact with a stop gear.

4. The motor control device according to claim 1, wherein the phase output unit includes a phase conversion unit that converts the phase of the voltage so as to increase a current to be passed through the phase exhibiting the low temperature.

5. The motor control device according to claim 4, wherein the voltage has N phases, and the phase conversion unit switches phases of the voltage in such a manner that an absolute value of a current value of one phase exhibiting the low temperature is increased, and phases near a position of the rotor of the alternating-current motor in the non-rotating state are selected as the N phases of the voltage.

6. The motor control device according to claim 4, wherein the phase output unit changes a cycle of the phases of the voltage so as to increase a ratio of time for which a high current is applied to a phase of the voltage, the phase being a phase exhibiting the low temperature, based on the temperature difference between the coils of the respective phases.

7. The motor control device according to claim 4, wherein the phase output unit changes the phases of the voltage cyclically, and, when there is no difference in the temperatures of the coils of the respective phases, changes a current command value and the phases of the voltage cyclically so as to equalize energy consumptions of the temperatures of the coils of the respective phases.

8. The motor control device according to claim 4, wherein the phase output unit shortens a voltage phase cycle time when a temperature of a switch element in the power conversion unit is higher than a cycle-changing temperature threshold, or when a rate of a temperature change of the switch element is greater than a cycle-changing temperature-change rate threshold.

9. The motor control device according to claim 7, wherein the phase output unit determines the current command value from a target loss value corresponding to each of the coils of the respective phases.

10. The motor control device according to claim 7, further comprising a torque direction calculation unit that calculates a direction of a torque in which the alternating-current motor does not move at all or moves only within a predetermined movement limit.

11. The motor control device according to claim 1, further comprising a target loss command unit configured to calculate a required amount of loss, from the temperatures of the coils and an outside air temperature, as the target loss values.

12. The motor control device according to claim 7, further comprising a vibration determination unit that detects vibration of a vehicle having the motor control device onboard, from a vibration of the alternating-current motor or the current command value having been changed,
wherein, when the vibration detected by the vibration determination unit or the temperature of the switch element of the power conversion unit exceeds a limit value, control for the phase of the current or the phases of the voltage is stopped, or the current command value is set smaller.

13. The motor control device according to claim 7, wherein the alternating-current motor is warmed up by causing the phase output unit to change the phases of the voltage from values of normal control, and to change the current command value.

14. The motor control device according to claim 5, wherein the voltage has three phases, and three-phase motor drive control is performed.
